(19) United States
(12) Patent Application Publication
(10) Pub. No.: US 2007/0263398 A1
(43) Pub. Date: Nov. 15, 2007

(54) Headlight optical axis angle control system and method

(75) Inventor: Ryu Mizuno, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/786,737

(22) Filed: Apr. 12, 2007

(30) Foreign Application Priority Data
May 12, 2006 (JP) 2006-134225

(51) Int. Cl. G01B 5/24

(52) U.S. Cl. 362/460

(57) ABSTRACT

A headlight optical axis angle control system for a vehicle has a headlight, a height sensor for detecting a height of the vehicle and an actuator for changing an optical axis angle of the headlight based on an output value of the height sensor. The system also has an ECU that detects an abnormal change in the output value of the height sensor, and drives the actuator to maintain the optical axis angle of the headlight unchanged irrespective of the output value of the height sensor when the abnormal change is detected.

### CROSS REFERENCE TO RELATED APPLICATION

This application is based on and incorporates herein by reference Japanese Patent Application No. 2006-134225 filed on May 12, 2006.

### FIELD OF THE INVENTION

The present invention relates to headlight optical axis angle control system and method for vehicles, which control the headlight optical axis angle in correspondence with an output of a height sensor.

### BACKGROUND OF THE INVENTION

A conventional adaptive front-lighting system (AFS) changes light radiation direction (optical axis angle) of headlights of a vehicle so that a forward area which a driver wants to look is illuminated. This system attains two controls. One is leveling control for changing a headlight optical axis angle in the vertical (up-down) direction and the other is swiveling control for changing a headlight optical axis angle in the horizontal (left-right) direction.

In the leveling control, as disclosed in JP 2005-350014A for instance, a pitch angle indicative of inclination of a vehicle is computed based on a difference between vehicle heights at a front part and a rear part, and a headlight optical axis angle is changed based on the computed pitch angle and the like to counter the difference in the vehicle heights. For instance, if the front height is lower than the rear height, the optical axis angle relative to the ground is increased so that the optical axis is moved more upward. With this leveling control, the headlight always illuminates a forward area, which is a predetermined distance from the vehicle, while not dazzling on-coming vehicles.

Height sensors are used to detect the front and rear heights of the vehicle. If an output value such as an output voltage of the height sensor exceeds a predetermined threshold level set for sensor failure detection, the height sensor is determined to be in failure. In the conventional system, however, it takes some time to determine the failure of the height sensor. Therefore, even if the front height sensor is disconnected and its output value instantly drops, the front height is detected as being lowered for some reason and optical axis angle is increased. This optical axis angle increase is likely to dazzle the on-coming vehicles.

### SUMMARY OF THE INVENTION

It is therefore an object of the present invention to provide headlight optical axis angle control system and method, which suppress headlight optical axis angle control in case of failure in a height sensor.

According to one aspect of the present invention, a headlight optical axis angle control system for a vehicle has a headlight, a height sensor for detecting a height of the vehicle and an actuator for changing an optical axis angle of the headlight based on an output value of the height sensor. The system further has an ECU that detects an abnormal change in the output value of the height sensor, and suppresses an angle changing operation of the actuator when the abnormal change is detected. The suppression may be maintaining the optical axis angle of the headlight unchanged irrespective of the output value of the height sensor.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic view showing a headlight optical axis angle control system according to an embodiment of the present invention;

FIG. 2 is a flowchart showing headlight optical axis angle control executed in the embodiment shown in FIG. 1;

FIGS. 3A and 3B are timing diagrams showing headlight optical axis angle control operations attained in the embodiment shown in FIG. 1 and in a prior art system, respectively; and

FIGS. 4A and 4B are timing diagrams showing headlight optical axis angle control operations attained in another embodiment of the present invention and in a prior art system, respectively.

### DETAILED DESCRIPTION OF THE EMBODIMENT

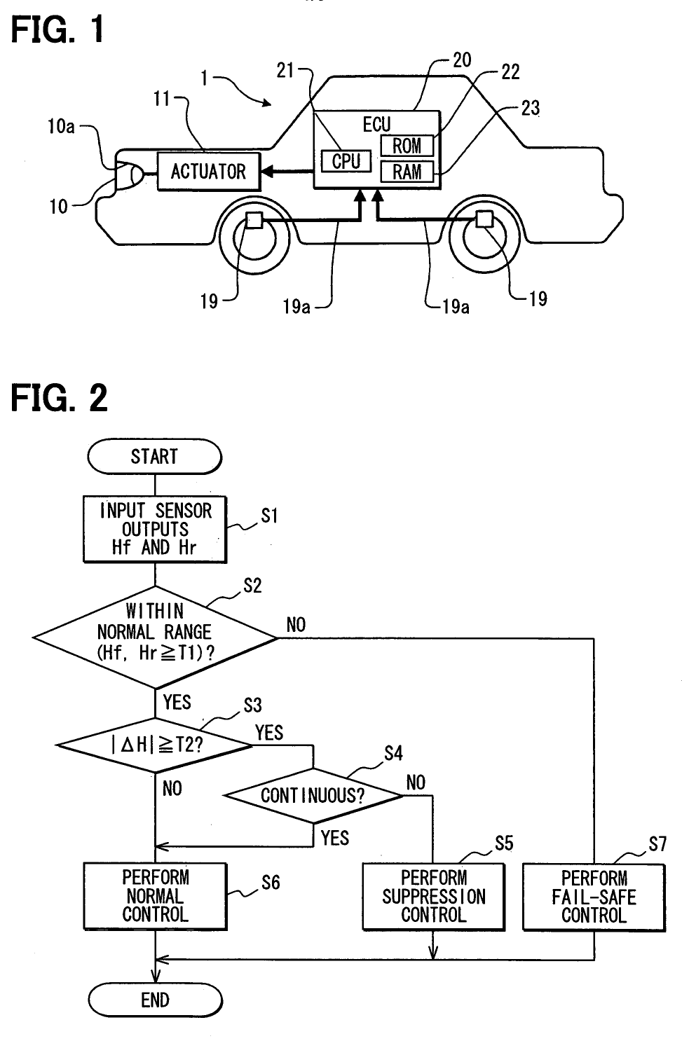

Referring first to FIG. 1, a headlight optical axis angle control system 1 includes a headlight 10, a leveling actuator 11, height sensors 19 and an electronic control unit (ECU) 20.

The head light 10 includes a light reflection plate 10a and provided on both left and right sides of a front end of a vehicle. The actuator 11 includes an electric motor and a motor drive circuit (not shown), which changes angle of the reflection plate 10a thereby changing the optical axis angle of the headlight 10. The height sensors 19 are mounted on a front axle part of front wheels and a rear axle part of rear wheels, and produce output voltages varying with heights of the front axle part and the rear axle part as vehicle front heights Hf and vehicle rear heights Hr. The height sensor 19 may be constructed to detect expansion/contraction of a suspension of the vehicle.

In this embodiment, a pitch angle of the vehicle against the ground may be expressed as tan⁻¹ {(Hf−Hr)/Wb, in which Wb is a wheel base between the front wheel axle and the rear wheel axle.

The ECU 20 includes a central processing unit (CPU) 21 for processing various arithmetic and logic operations, a ROM 22 for storing control programs, a RAM 23 for storing various data, and other related component parts. The ECU 20 is connected to the height sensors 19 through signal wires 19a to receive the output voltages of the height sensors 19. The ECU 20, particularly CPU 21, computes a pitch angle (front-rear inclination) of the vehicle and computes optical axis angle based on front and rear heights Hf and Hr indicated by the sensor output voltages, and computes an optical axis angle control value to thereby control the optical axis angle of the headlight 10 through the actuator 11. In the normal optical axis angle control, the ECU 20 increases and decreases the optical axis angle relative to the ground when the front height Hf becomes lower and higher than the rear heights Hr, respectively. Thus, the headlight 10 is controlled to illuminate a front area up to a predetermined distance ahead of the vehicle and not to dazzle on-coming vehicles or the like.

The ECU 20, more specifically CPU 21, is constructed to execute optical axis angle control processing shown in FIG. 2 at every predetermined interval.

The CPU 21 first inputs at step Si output values Hf and Hr of the output voltage of the height sensors 19 after analog-to-digital conversion. The output values Hf and Hr normally correspond to the front height and the rear height of the vehicle, respectively, as long as the height sensors 19 operate normally. The CPU 21 then checks at step S2 whether the sensor output values Hf and Hr are within a predetermined normal range. For instance, if the height sensor 19 is connected to the ECU 20 through the wire 19a in such a manner that the output value decreases when the height sensor 19 or signal wire 19a is disconnected, the height sensor 19 may be determined to be normal when the output value is equal to or larger than a predetermined threshold level T1. If the output value is in the normal range, the CPU 21 further computes at step S3 a time-change |ΔH| of the height, that is, an absolute value of a change between the presently inputted value and the previously inputted value, and compares this time-change with a predetermined threshold level T2. This time-change computation and comparison may be performed for each of the output values of the front height sensor and the rear height sensor.

If the time-change |ΔH| is smaller than the threshold level T2 and normal, the CPU 21 perform normal optical axis angle control at step S6 in accordance with a pitch angle computed as a difference between the output values Hf and Hr indicative of the front height and the rear height. In this normal control, the optical axis angle is changed within a predetermined angle range (e.g., ±3°) in the vertical direction. If the time-change |ΔH| is equal to or larger than the threshold level T2 and abnormal, the CPU 21 checks at step S4 whether the time-change |ΔH| continues to be larger than the threshold level T2 for more than a predetermined time, that is, whether more than the predetermined time has passed after the time-change |ΔH| has first became larger than the predetermined level T2.

If it is not more than the predetermined time, that is, it is right after a large time-change, the CPU 21 performs at step S5 suppression control, in which the actuator 11 is driven to maintain the optical axis angle unchanged from the optical axis angle attained when the time-change |ΔH| has first became larger than the threshold level T2. That is, the present optical axis angle is maintained irrespective of changes in the pitch angle, etc. This suppression control at step S5 is performed only during the predetermined time after the time-change becomes larger than the threshold level T2.

If the time-change |ΔH| continues to be larger than the threshold level T2 for more than the predetermined time while the sensor output is within the normal range, the height sensor 19 and the signal wire 19a are considered to be operating normally. Therefore, in this case, the CPU 21 switches its control form the suppression control (step S5) to the normal control (step S6).

If the sensor output is not within the normal range, that is, the height Hf or Hr is smaller than the threshold level T1, the height sensor 19 or the signal wire 19a is in failure such as disconnection. Therefore, the CPU 21 performs fail-safe control at step S7 following step S2. In this fail-safe control, the CPU 21 may drive the actuator 11 to a predetermined angle (e.g., ±0°) relative to the ground or maintain the optical axis angle unchanged. The fail-safe control may be delayed a certain period.

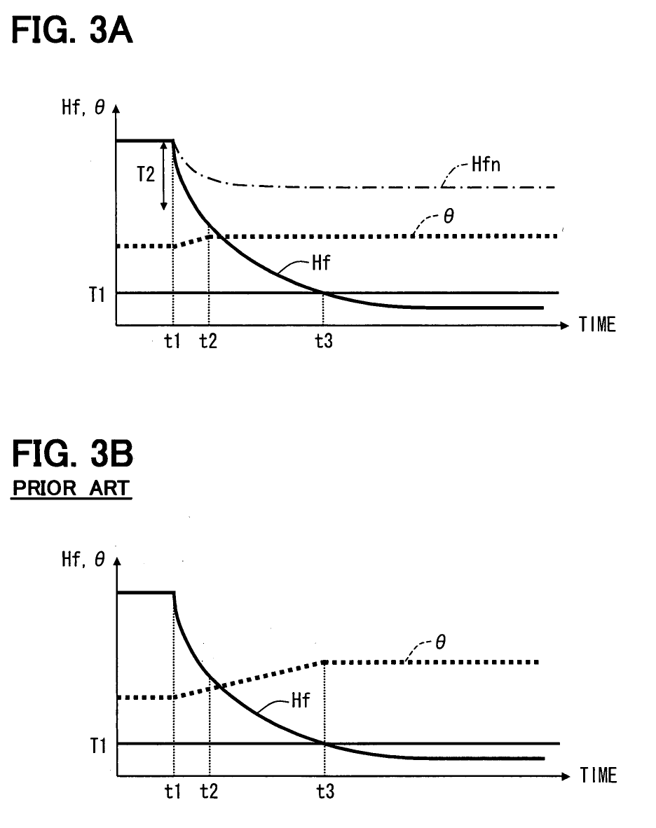

The operation of the above embodiment is shown in FIG. 3A in comparison with a prior art example shown in FIG. 3B, in which no suppression control is performed.

In FIGS. 3A and 3B, it is assumed that the signal wire 19a of the height sensor 19 that detects the front height Hf is disconnected at time point to and hence the front height Hf greatly decreases as shown by solid lines. As shown in FIG. 3B, the optical axis angle 0 shown by dotted line is continuously increased as the output value Hf inputted to the ECU 20 decreases in the prior art system. This continuous increase may result in dazzling on-coming vehicles. The optical axis angle E is maintained unchanged as the fail-safe control from time point t3 after the output value Hf becomes smaller than the threshold level T1.

According to the embodiment, in the same situation that the signal wire 19a is disconnected, the output value Hf decreases at greater speed than a normal decrease Hfn indicated by a dot-and-chain line as shown in FIG. 3A. As a result, the optical axis angle θ shown by the dotted line starts to be increased. However, this increase is stopped and maintained unchanged after time point t2, when the time-change |ΔH| in the output value Hf becomes larger than the threshold level T2. When the output value Hf further decreases below the threshold level T1, the fail-safe control is performed after time point t3 by maintaining the optical axis angle unchanged or by controlling the same to a predetermined angle. It is to be noted that, in the case of disconnection of the signal wire 19a of the height sensor 19 for detecting the rear height Hr, the optical axis angle θ is controlled to decrease. However, the decrease is suppressed and limited in the similar manner as described above.

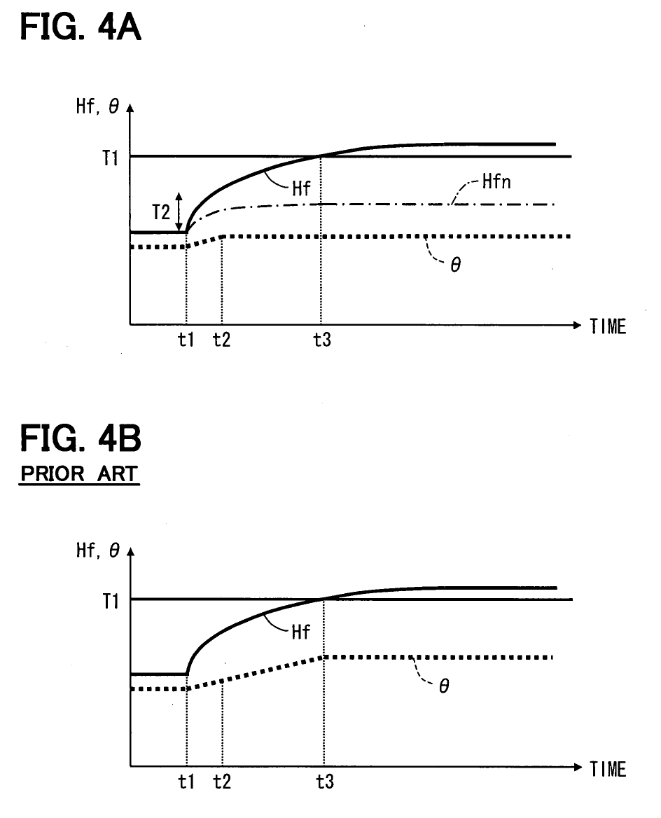

Contrary to the above embodiment, the height sensors 19 and signal wires 19a may be constructed in such a manner that the output value of the height sensor 19 increases when the associated signal wire 19a is disconnected. In this case, according to the prior art system, as shown in FIG. 4B, the optical axis angle 8 is continuously increase until time point t3. However, with the suppression control, as shown in FIG. 4A, the optical axis angle θ is increased only slightly after time point t1 and maintained unchanged after time point t2, at which time the time-change |ΔH| reaches the threshold level T2.

The above embodiments may be further modified in various ways without departing from the scope of the present invention.

What is claimed is:

1. A headlight optical axis angle control system for a vehicle having a headlight, a height sensor for detecting a height of the vehicle and an actuator for changing an optical axis angle of the headlight based on an output value of the height sensor, the headlight optical axis angle control system comprising:
an abnormal change detection means for detecting an abnormal change in the output value of the height sensor; and
a control means for suppressing an angle changing operation of the actuator when the abnormal change is detected.

2. The headlight optical axis angle control system according to claim 1,
wherein the control means maintains the optical axis angle of the headlight unchanged irrespective of the output value of the height sensor in suppressing the angle changing operation.

3. The headlight optical axis angle control system according to claim 2,
wherein the abnormal change detection means compares a time-change in output values of the height sensor in a predetermined interval with a predetermined threshold level, and detects the abnormal change when the time-change is larger than the predetermined threshold level.

4. The headlight optical axis angle control system according to claim 1,
wherein the control means suppresses the angle changing operation of the actuator for a predetermined period after the abnormal change is detected, and then allows a normal angle changing operation of the actuator after the predetermined period when the output value of the height sensor is within a normal range.

5. The headlight optical axis angle control system according to claim 1, further comprising:
a failure detection means for detecting a failure of the height sensor when the output value of the height sensor is outside a predetermined normal range,
wherein the control means drives the actuator for a predetermined fail-safe operation, when the failure is detected.

6. A headlight optical axis angle control method for a vehicle having a headlight, a height sensor for detecting a height of the vehicle and an actuator for changing an optical axis angle of the headlight based on an output value of the height sensor, the headlight optical axis angle control method comprising:
detecting an abnormal change in the output value of the height sensor; and
driving the actuator to maintain the optical axis angle of the headlight unchanged irrespective of the output value of the height sensor when the abnormal change is detected.

7. The headlight optical axis angle control method according to claim 6,
wherein the detecting compares a time-change in output values of the height sensor in a predetermined interval with a predetermined threshold level, and detects the abnormal change when the time-change is larger than the predetermined threshold level.

8. The headlight optical axis angle control method according to claim 6, further comprising:
continuing to drive the actuator to maintain the optical axis angle unchanged for a predetermined period after the abnormal change is detected; and
driving the actuator to perform a normal angle changing operation of the actuator after the predetermined period when the output value of the height sensor is within a normal range.

9. The headlight optical axis angle control method according to claim 6, further comprising:
detecting a failure of the height sensor when the output value of the height sensor is outside a predetermined normal range; and
driving the actuator to perform a predetermined fail-safe operation different from maintaining the optical axis angle unchanged, when the failure is detected.
